(19) United States
(12) Patent Application Publication
(10) Pub. No.: US 2001/0026299 A1
(43) Pub. Date: Oct. 4, 2001

(54) Ink-jet printing apparatus and recovery processing method of ejection port

(76) Inventors: Akira Tsujimoto, Yokohama-shi (JP); Junji Shimoda, Chigasaki-shi (JP); Tadayoshi Inamoto, Tokyo (JP); Isao Kimura, Kawasaki-shi (JP); Aya Yoshihira, Yokohama-shi (JP); Kiyomitsu Kudo, Kawasaki-shi (JP); Tooru Suzuki, Kawasaki-shi (JP)

Correspondence Address: FITZPATRICK CELLA HARPER & SCINTO, 30 ROCKEFELLER PLAZA, NEW YORK, NY, 10112, US

(21) Appl. No.: 09/817,261

(22) Filed: Mar. 27, 2001

(30) Foreign Application Priority Data
Mar. 28, 2000 (JP) 2000-89654

(51) Int. Cl. B41J 2/165

(52) U.S. Cl. 347/30

(57) ABSTRACT

An ink-jet printing apparatus, a cap and an ejection recovery method can satisfactorily perform recovery process for respective of ejection openings having different ink flow resistance and permit down-sizing. The ink-jet printing apparatus includes a printing head having a plurality of ejection openings and covering cap on the ejection opening face where a plurality of ejection openings of the printing head, and recovery means sucking ink in the ejection openings covered by the cap. The ink-jet printing apparatus also includes a sealing member for sealing predetermined ejection openings as a part of a plurality of ejection openings provided within the cap.

This application is based on Patent Application No. 2000-89654 filed Mar. 28, 2000 in Japan, the content of which is incorporated hereinto by reference.

### BACKGROUND OF THE INVENTION

1. Field of the Invention

The present invention relates to an ink-jet printing apparatus, a recovery processing method of an ejection port. More particularly, the invention relates to an ink-jet printing apparatus and a recovery processing method of an ejection port having a function for recovering or maintaining good ink ejection performance of a printing head.

2. Description of the Related Art

Associating with spreading of information processing equipment, printing apparatus as their peripheral equipment have also been spread. Particularly, an ink-jet printing apparatus performing printing by ejecting ink droplets from a plurality of ejection openings provided in a printing head toward a printing medium, have been rapidly spreading for a reason that color printing can be performed easily. Furthermore, associating with demand for down-sizing, there have been proposed serial type ink-jet printing apparatus, in each of which alternately repeats a printing operation moving the printing head in a predetermined direction and ejecting ink droplets during movement of the printing head and a paper feeding operation for feeding the printing medium for a predetermined amount in a direction perpendicular to motion direction of the printing head.

In such ink-jet printing apparatus, the printing head is frequently mounted on a carriage which can scan in a predetermined direction. In case of full-color printing, each of the printing heads for respective colors of yellow, magenta, cyan and black, is constructed by integrating an ejection opening array and an ink tank. Also, among the printing heads, there are some printing head, in which only ink tank is detachable.

On the other hand, as a color image can be easily processed by information processing equipment, there has been an increasing demand for the ink-jet printing apparatus that readily print those images in full-color printing, thereby being required enhanced image quality of printing result. As means for meeting the demand, there has been proposed an ink-jet printing apparatus in which high image quality is realized by employing multi-gradation levels of density being printable using the following method.

For example, concerning magenta and cyan, two kinds of inks having mutually different densities, namely, high density ink and low density ink are provided for dividing ink densities of image data into greater number of gradation levels for performing printing with such high and low densities, or in the alternative, by switching ink ejection amount to be ejected from the printing head using only one kind of ink in each color, depending upon ink density of the image data to perform printing with different sizes of dots on the printing medium for realizing high gradation level and high image quality.

Particularly, the method for increasing gradation levels by forming different sizes of dots on the printing medium by switching ink ejection amounts can restrict the number of ink tanks to be loaded. Therefore, such method is effective for down-sizing of ink tanks and down-sizing of the ink-jet printing apparatus.

The printing head switching the ink ejection amount has been disclosed in Japanese Patent Application Laid-open No. 9-254413 (1997) and Japanese patent Application laid-open No. 9-48125 (1997). In the above-identified publications, it has been proposed to differentiate ejection amount by arranging a plurality of rows of ejection openings on an ink ejection face and differentiating sizes of ejection openings per row of the ejection openings.

By performing printing operation for many times or by leaving inoperative for a long period, it is possible in a printing head to cause variation of ejection amount and/or ejecting direction for deposition of dust and dirt around the ejection opening or plugging of ink of increased density. In the alternative, ink may be dried to make ejection unstable upon initiation of printing.

In order to prevent drying of ink or ejection failure, the ink-jet printing apparatus covers the ejection opening face with a cap while printing head is not used, or is provided means for performing preparatory ejection at a predetermined position out of printing portion. For example, in an ink-jet printing apparatus disclosed in Japanese Patent Application Laid-open No. 10-100451 (1998), a cap covering a plurality of ejection openings is provided.

On the other hand, in case of the printing head, in which only ink tank is detachable, when old ink tank is removed, air may penetrate into an ink passage connecting the ink tank and the ejection opening, or air may penetrate around the ejection opening. Therefore, when the ink tank is exchanged with new ink tank, re-filling of the ink becomes necessary up to around the ejection opening. Therefore, upon exchanging the ink tank, the ejection opening face is covered with the cap to perform suction of the ink by a suction means with driving a pump.

Such recovery operation by the preparatory ejection means, suction means and so on are performed during printing operation, or non-printing operation or upon exchanging of the ink tank or the like.

FIGS. 8A and 8B are sections showing a printing head portion and recovery unit portion of the conventional ink-jet printing apparatus.

As shown in FIG. 8A, a printing head 83 is mounted on a head carriage frame 83a movably arranged on a pair of upper and lower guide members 82. The printing head 83 is provided with two ejection opening portions 83b and 83c projecting downwardly from the lower surface of the head carriage frame 83a, namely from a surface opposing to the printing medium feeding passage, a black ink tank 83d and a color ink tank 83e arranged detachably on the head carriage frame 83a.

In the ejection opening portions 83b and 83c are formed with a plurality of ejection openings, respectively. Then, the ejection opening portion 83b ejects black ink supplied from the black ink tank 83d and the ejection opening portion 83c ejects three kinds of inks of cyan, magenta and yellow supplied from the color ink tank 83e. It should be noted that the black ink ejection openings 83f, the yellow ejection openings 83g, the magenta ink ejection openings 83h and the cyan ink ejection openings 83f are provided in plural. However, for the purpose of illustration, each one ejection opening is illustrated.

The ink-jet printing apparatus feeds a printing medium by means of a not shown printing medium feeding member, reciprocally scans the printing head and ejects ink droplet from respective ejection openings to form a desired image on the printing medium.

As shown in FIG. 8B, a recovery unit 810 for providing recovery process for the printing head 83 is provided. To the recovery unit 810, caps 89b and 89c for covering the ejection openings 83b and 83c are provided. The caps 89b and 89b are connected to not shown pumps. The recovery unit 810 moves up and down to cover the ejection openings 83b and 83c with the caps 89b and 89c and performs suction by the pumps.

A plurality of ejection openings are arranged on the ejection opening face of the printing head. Among variety of ink-jet printing apparatus, some of the ink-jet printing apparatus have opening portions of the ejection openings having not uniform size and rather differentiate per row of ejection openings to permit printing of image at higher resolution. When a plurality of kinds of ejection openings of different shapes are present, the conventional ink-jet printing apparatus is provided the caps in number corresponding to shapes and kinds of the ejection openings to require large space and whereby to hinder down-sizing of the overall apparatus. On the other hand, when attempt is made to perform suction for all ejection openings by one cap, fluctuation can be caused in suction for difference of flow resistance of the ink per the shape of the ejection openings.

Particularly, the row of the ejection openings having high flow resistance lacks ink suction force if the same suction force is applied in comparison with the row of the ejection openings having low flow resistance upon cap suction to make it impossible to effectively perform suction recovery. In order to perform suction for the row of the ejection openings having high flow resistance, long period is required in suction operation, or the ink of increased viscosity plugging within the ejection openings cannot be sucked satisfactorily. On the other hand, the row of the ejection openings having low flow resistance is sucked unnecessarily large amount of ink if the suction process the same as the ejection openings having high flow resistance is performed to waste the ink. Furthermore, excessive suction may cause retention of bubble within the ejection opening to possibly make normal ink ejection impossible.

### SUMMARY OF THE INVENTION

The present invention has been worked out for solving the problem in the prior art. Therefore, it is an object of the present invention to provide an ink-jet printing apparatus and an recovery processing method of a ejection port which can satisfactorily perform recovery process for respective of ejection openings having different ink flow resistance and permit down-sizing.

According to one aspect of the present invention, a ink-jet printing apparatus including a printing head having a plurality of ejection openings and a cap covering on the ejection opening face where a plurality of ejection openings of the printing head is arranged, and suction means sucking ink from the ejection openings covered by the cap, comprises a sealing member for being provided within the cap and for sealing a part of ejection openings of the plurality of ejection openings. In the ink-jet printing apparatus, when the part of plurality of ejection openings are by the a sealing member, operation for sucking ink from the ejection openings which are not sealed, is preformed by the suction means.

According to another aspect of the present invention, an ink-jet printing apparatus has a cap for covering an ejection opening face of a printing head in which a plurality of ejection openings are arranged, wherein the cap comprises a projecting lip portion surrounding a plurality of ejection openings when the cap covers the ejection opening face and a projecting portion formed inside surrounded by the lip portion and sealing a part of ejection openings of the plurality of ejection openings, and wherein when the lip portion contacts with the ejection opening face at a predetermined position, the projecting portion seals the part of ejection openings, and when the cap moves in a direction parallel to the ejection opening face to contact with the ejection opening face at a position different from the predetermined position, the projecting portion does not seal the part of ejection openings.

According to another aspect of the present invention, an ink-jet printing apparatus has a cap for covering an ejection opening face of a printing head in which a plurality of ejection openings are arranged, wherein the cap comprises a projecting lip portion surrounding a plurality of ejection openings when the cap covers the ejection opening face, a deformable lip portion formed at the projecting tip end of the lip portion, and a projecting portion formed inside surrounded by the lip portion and sealing a part of ejection openings as a part of the plurality of ejection openings, and wherein when the lip portion is applied a predetermined contact force at a predetermined position to contact with the ejection opening face, the deformable lip portion is deformed and the projecting portion seals the part of ejection openings, and when the lip portion is applied a force less than the predetermined contact force at the predetermined position to contact with the ejection opening face, the deformable lip portion is not deformed and the projecting portion does not seal the part of ejection openings.

According another aspect of the present invention, an ink-jet printing apparatus has a cap for covering an ejection opening face of an ink head in which a plurality of ejection openings are arranged, wherein the cap comprises a projecting lip portion surrounding a plurality of ejection openings when the cap covers the ejection opening face, a projecting portion formed inside surrounded by the lip portion and sealing part of ejection openings as a part of the plurality of ejection openings, and projecting portion actuating portion for moving the projecting portion for sealing the part of ejection openings the part of ejection openings when suction process of the ejection openings other than the part of ejection openings is performed, and for moving the projecting portion for releasing the seal of the part of ejection openings while suction process of the part of ejection openings is performed.

According to another aspect of the present invention, an ejection recovery processing method of an ejection port comprises covering step of covering by a cap an ejection opening face arranged a plurality of ejection openings, sealing step for sealing a part of ejection openings of the plurality of ejection openings by sealing member provided within the cap, and suction step for sucking the ink from ejection openings not sealed by the sealing member in the sealing step.

By employing the above structure, upon covering the ejection opening face with the cap at the predetermined position, the projecting portion is contacted with the predetermined row of the ejection openings, such as the ejection openings having low flow resistance to seal the predetermined row of the ejection openings. By performing suction in this condition, ink is sucked from the row of the ejection openings other than the predetermined row of ejection openings. Then, after sufficiently sucking the ink from the row of ejection openings other than the predetermined row of ejection openings, the cap is moved to release sealing by the projecting portion to effect sucking. Then, ink is sucked from the predetermined row of ejection openings. Thus, ink can be sucked from all of the ejection openings in just proportion.

The above and other objects, effects, features and advantages of the present invention will become more apparent from the following description of embodiments thereof taken in conjunction with the accompanying drawings.

### BRIEF DESCRIPTION OF THE DRAWINGS

FIG. 1 is a perspective view of an ink-jet printing apparatus;

FIG. 2 is a perspective view of a printing head and an ink tank;

FIG. 3 is a diagrammatic illustration showing an ejection opening face;

FIG. 4 is a perspective view of a cap;

FIGS. 5A to 5C are sections showing a state of contact between the cap and the ejection opening face, in which

FIG. 5A shows non-contacting condition,

FIG. 5B shows first recovery stage and

FIG. 5C denotes second recovery stage;

FIGS. 6A to 6C are sections showing a state of contact between another embodiment the cap and the ejection opening face, in which

FIG. 6A shows non-contacting condition,

FIG. 6B shows first recovery stage and

FIG. 6C denotes second recovery stage;

FIGS. 7A and 7B are sections showing a state of contact between another embodiment of the cap and the ejection opening face, in which

FIG. 7A shows first recovery stage and

FIG. 7B denotes second recovery stage; and

FIGS. 8A and 8B are sections showing the conventional printing head portion and a recovery unit portion, in which

FIG. 8A shows the printing head portion and

FIG. 8B shows the recovery unit portion.

### DETAILED DESCRIPTION OF PREFERRED EMBODIMENTS

Embodiments of the present invention will be discussed hereinafter with reference to the drawings.

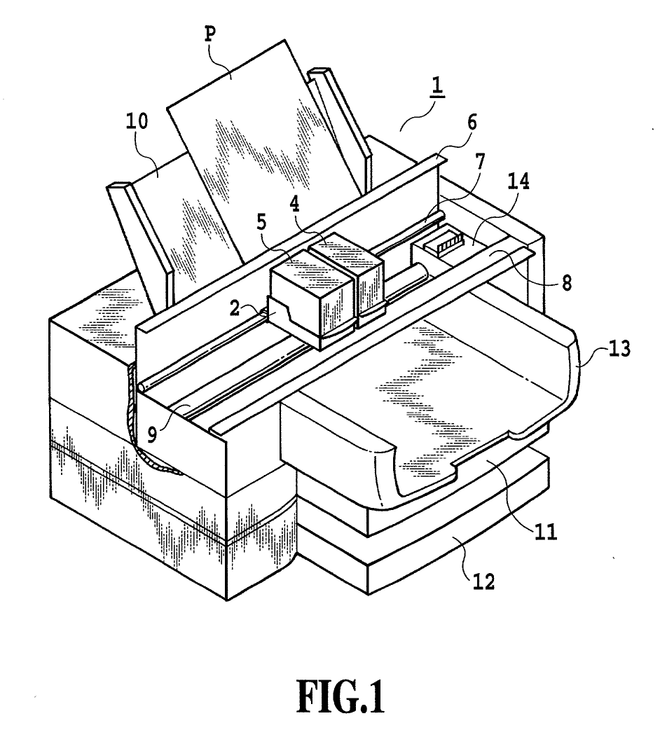

FIG. 1 is a perspective view of one embodiment of an ink-jet printing apparatus according to the present invention.

The ink-jet printing apparatus 1 has a carriage 2. To the carriage 2, a printing head (not shown), a black ink tank 4 storing a black ink, a color ink tank 5 storing cyan, magenta and yellow inks are provided. The carriage 2 is fixed on a frame 6 at both end portions for movement along a guide shaft 7 and a guide rail 8 disposed in parallel to the frame 6. The carriage 2 is moved by a driving force of a carriage motor (not shown) transferred through a carriage belt (not shown). The carriage motor is constructed with a stepping motor or the like.

On the other hand, a printing medium P stacked on an automatic sheet feeder 10 or upper cassette 11 and lower cassette 12 is fed by a paper feeding mechanism (not shown) and is fed to a predetermined print start position as pinched by the feeding roller 9 and a pinch roller (not shown). Then, the carriage 2 performs scan. During scanning by the carriage 2, the printing head performs printing. When one path of scan is completed, the printing medium is fed for a predetermined amount in a direction perpendicular to the scanning direction of the carriage 2. By repeating printing operation and feeding operation, printing over the entire printing medium can be performed.

On the other hand, the ink-jet printing apparatus 1 performs recovery operation by a recovery mechanism 14 during standby of a command of printing or before and after printing operation or at appropriate timing on printing in order to recover performance or maintain good condition of the printing head. In the recovery mechanism, a cap, a suction pump, a wiping member and so on are provided. It should be noted that the construction and operation of the recovery mechanism will be explained later.

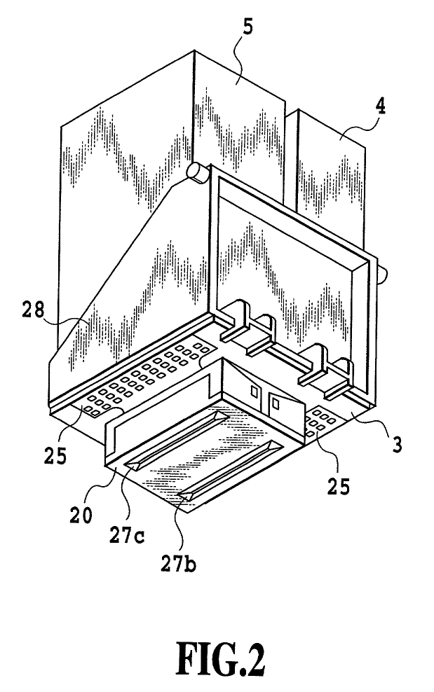

FIG. 2 is a perspective view of the printing head and the ink tank.

The printing head 3 is provided with ejection opening face 20 on the surface opposing to the printing medium as loaded on the carriage, and is provided with rows of ejection openings 27b and 27c arranged a plurality of ejection openings on the ejection opening face. Each election opening is applied an electrical signal necessary for ink ejection by an electrical circuit board 25. The electrical circuit board 25 contacts with a predetermined position in a holder of the carriage when the printing head 3 is loaded on the carriage. The electrical signal is received from the contact point.

On the other hand, the black ink tank 4 and the color ink tank 5 are detachably loaded in a head holder 28. The ink of the black ink tank 4 is filled up to each ejection openings of the row of the ejection openings 27b via an ink supply passage (not shown). Similarly, each ink of the cyan, magenta, yellow of the color ink tank 5 is also filled up to each ejection opening of the row of ejection openings 27c via the ink supply passage.

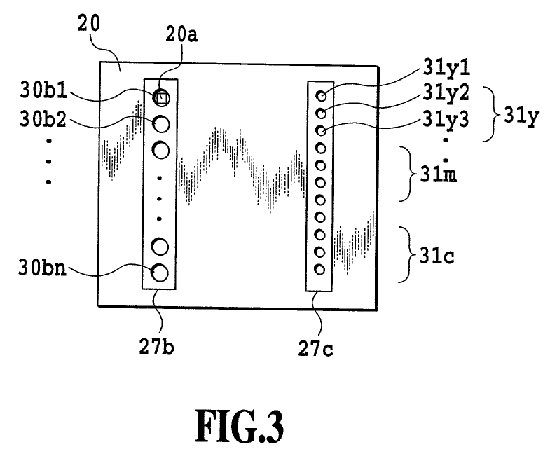

FIG. 3 is a diagrammatic illustration showing the ejection opening face.

In the row of the ejection openings 27b ejecting the black ink, n in number of ejection openings 30b1, 3b2, . . . 30bn are arranged in alignment. Size of each ejection opening 30 is 22 μm×22μm. From each ejection opening 30, an ink passage (not shown) is extended. Each ink passage is communicated with an ink chamber (not shown). The ink of the black ink tank is filled up to each ejection opening via the ink chamber from the ink supply passage. Furthermore, to each ink passage, a heater 20a is provided corresponding to each ejection opening 30. In FIG. 3, only heater corresponding to ejection opening 30b1 is illustrated. Upon ejecting the ink, the heater is heated to generate bubble in the ink. Then, by generation pressure of bubble, a predetermined amount of ink droplet is ejected. In the shown, a heater size is 26×32 μm² and ejection amount is 8×10⁻¹⁵ m³ (8 pl).

The row of the ejection openings 27c ejecting respective colors of color inks is divided per n in number for each ink color. Ejection openings 31y1 . . . 31yn for ejecting the yellow ink, the ejection openings 31m1 . . . 31mn for ejecting the magenta ink and the ejection openings 31c1 . . . 31cn for ejecting the cyan ink are arranged in alignment. The ejection opening 31 of the row of the ejection openings 27c also has a mechanism for ejecting the ink in the same construction as the ejection opening 30. The size of the ejection opening 31 is smaller than that of the ejection opening 30 and is 17×17 μm². The size of the corresponding heater is 24×26 μm², and ejection amount is 4×10⁻¹⁵ m³ (4 pl).

It should be noted that the arrangement pitch of the rows of the ejection opening in the shown embodiment is 42.3 μm to establish an arrangement for enabling pixel formation corresponding to 600 dpi of printing density. The arrangement pitch may be appropriately determined for desired image formation. On the other hand, rows of the ejection openings are formed by two rows in the shown embodiment. However, it is also possible to arrange further greater number of rows of ejection openings. For example, each row may be formed with ejection openings for each color of cyan, magenta, yellow and black.

Since sizes of the ejection openings are difference in the row of ejection openings 27b and the row of ejection openings 27c, flow resistances in the ejection openings are also different. For satisfactorily perform ink suction for respective of two kinds of rows of ejection openings with different flow resistances without wasting the ink, the shown embodiment of the recovery mechanism has the following construction.

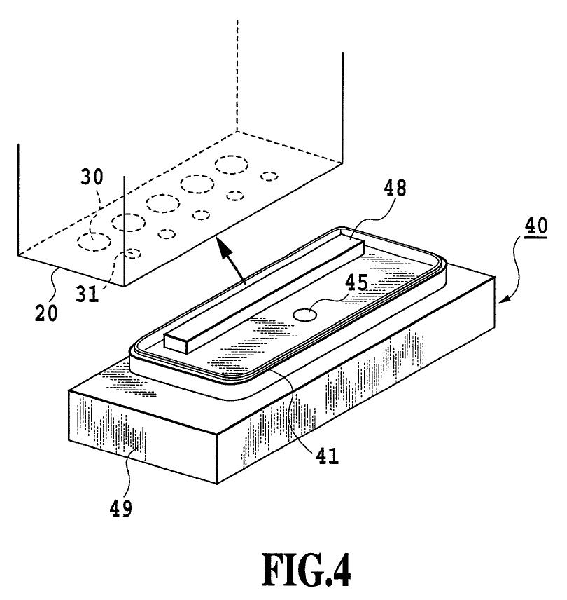

FIG. 4 is a perspective view of the cap.

The cap 40 comprises a lip portion 41 projecting circumferentially on a base portion 49. Upon contacting the cap 40 onto the ejection opening face 20, the lip portion 41 abuts onto the ejection opening face 20. Upon abutting, rows of the ejection openings 27b and 27c are surrounded by the lip portion 41.

On the other hand, on inside of the lip portion 41, ink suction opening 45 is provided. The ink suction opening 45 is communicated with a suction pump (not shown). When the suction pump is driven, dust and dirt deposited on the ejection opening or ink having increased viscosity are sucked from the ink suction opening 45.

Furthermore, adjacent the ink suction opening, projecting portion 48 is provided along the longitudinal direction of the lip portion 41. A height of the projecting portion 48 is substantially the same height as the circumferential lip portion 41.

As the material of the cap 40, an elastic body, such as rubber or the like for certainly providing gas tightness upon abutting the lip portion 41 onto the ejection opening face 20, is used. Furthermore, in the light of wettability of the ink, chlorinated butyl rubber, silicone rubber and like are preferred. It is preferred that the material of the projecting portion 48 is the same as the material of the cap 40.

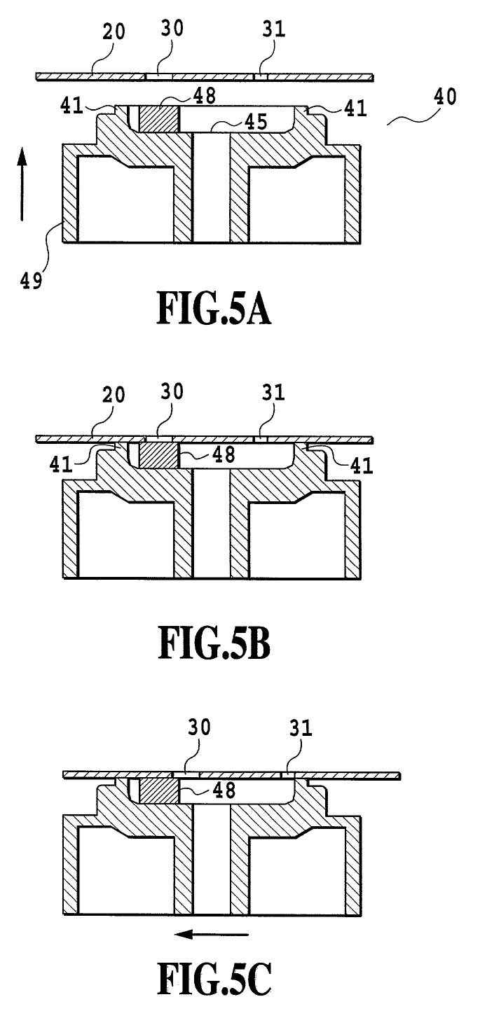

FIGS. 5A to 5C are sections showing state of abutment between the cap and the ejection opening face.

Upon initiation of recovery process, the carriage is moved so that the printing head is positioned in opposition to the cap. When the printing head reaches the position opposing to the cap, the cap 40 is elevated upward as shown in FIG. 5A to abut onto the ejection opening face 20 of the printing head. It should be noted that the printing head is placed at a position where both of the rows of the ejection openings 27b and 27c are surrounded by the lip portion 41.

When the cap 40 is elevated upward and the lip portion 41 abuts onto the ejection opening face 20 of the printing head, the projecting portion 48 having the same height as the lip portion 41, as shown in FIG. 5B, contacts with the ejection openings 30 to seal the ejection openings 30.

As set forth, since the ejection opening 30 has greater open area than that of the ejection opening 31. Accordingly, the ejection opening 30 has smaller flow resistance than the ejection opening 31 upon suction of the ink. Therefore, if pump is driven in opening condition of both of the ejection opening 30 and the ejection opening 31 without sealing the ejection opening 30 by the projecting portion 48, ink is mainly sucked from the ejection opening 30 having smaller flow resistance, and the ink is difficult to be sucked from the ejection opening 31. However, when suction is performed after sealing the ejection opening 30 side having low flow resistance, the ink is sucked from the ejection opening 31 and ink is not sucked from the ejection opening 30. In the shown embodiment, the suction operation in the condition shown in FIG. 5B is referred to as first recovery stage. In the first recovery stage, the ejection openings having small flow resistance and large ejection amount are selectively sealed to perform suction process for remaining ejection openings not sealed.

When the suction process of the ejection opening 31 is satisfactorily performed, the cap 40 is moved downwardly away from the printing head and is moved in arrangement direction of the rows of the ejection openings 27b and 27c for a predetermined amount (direction shown by arrow) in parallel. Then, the printing head is again elevated upward to contact with the ejection opening face 20. At this time, as shown in FIG. 5C, the projecting portion 48 contact at the position not to seal the ejection opening 30. Namely, the cap 40 is abutted in the condition where both of the ejection openings 30 and 31 are sealed. By performing suction by driving the suction pump in this condition, ink is mainly sucked from the ejection opening 30 sealed in the first recovery stage. This is referred to as second recovery stage.

As set forth above, by performing suction with sealing the ejection openings having low flow resistance in the first recovery stage, and by performing suction with removing seal of the ejection openings 30 in the second recovery stage, ink suction in just proportion can be performed for respective ejection openings. Namely, with one cap, suction for a plurality of kinds of ejection openings can be performed in just proportion.

In the shown embodiment, after completion of first recovery stage and in transition to the second recovery stage, the cap 40 is moved down and moved for the predetermined amount in the direction shown by arrow, and then is moved upward again to contact with the ejection opening face 20 to place the projecting portion 48 out of contact with the ejection openings 30. However, it is also possible to take a construction that, after lowering the cap 40, the printing head is moved for the predetermined amount in the direction opposite to the direction of arrow and stopped, and then the cap 40 is elevated up to contact with the printing head.

(Second Embodiment)

In the shown embodiment, explanation will be given for the structure of the lip portion of the cap different from the first embodiment.

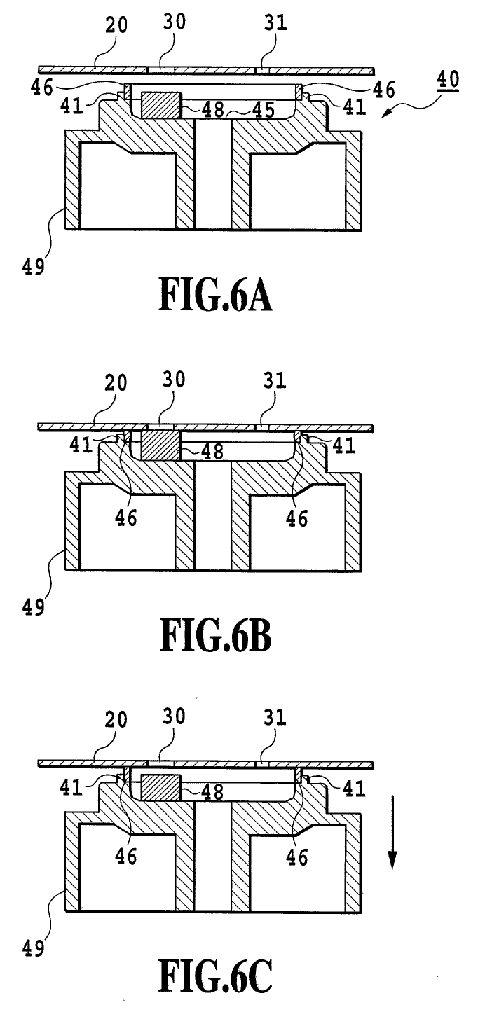

FIGS. 6A to 6C are sections showing the cap and the printing head ejection opening face.

As shown in FIG. 6A, the shown embodiment of the cap 40 is further provided projection 46 at the tip end of the lip portion 41. The projection 46 is located at the position higher than the projecting portion 48. Then, similarly to the lip portion 41, the projection 46 is formed with a material softer than the lip member 41 formed with elastic body.

Similar to the first embodiment, when the recovery process is initiated, the carriage is moved to the position where the printing head opposes with the cap. When the printing head reaches the position opposing to the cap, the cap 40 is elevated upward to contact with the ejection opening face 20 of the printing head. Contacting is performed at the position where the lip portion 41 surrounds both of the ejection openings 30 and 31.

Then, at the first recovery stage, the projection 46 provided at the tip end of the lip portion 41 contacts with the ejection opening face 20. Even after contacting the projection 46 onto the ejection opening face 20, the cap 40 is further elevated upwardly. As shown in FIG. 6B, by further upward movement of the cap 40, the projection 46 is collapsed by elastic deformation to be turned toward the lip portion 41. When the projection 46 is collapsed, the projecting portion 48 contacts with the ejection opening face 20 to seal the ejection openings 30. By operating the suction pump in this condition, the ink is sucked from the ejection openings 31 which are not sealed.

After completion of suction operation in the first recovery stage, the cap 40 is lowered for a predetermined amount. A magnitude of lowering of the cap 40 is in the extent to slightly weaken contact force to the ejection opening face 20. Furthermore, as shown in FIG. 6C, the collapsed projection 46 restores the original shape to contact with the ejection opening face 20 in restored shape. Furthermore, by lowering of the cap 40, the projecting portion 48 sealing the ejection openings 30 is released away from the ejection openings 30. Since the projection 46 is located at higher position than the projecting portion 48, a gap is formed between the projecting portion 48 and the ejection openings 30. At this condition, when the suction pump is driven, the ink is mainly sucked from the ejection openings 30 having low flow resistance. It should be noted that the position where the cap 40 is lowered and stopped is that the projection 46 contact with the ejection opening face 20 without collapsing to make the inside of the lip portion 40 in enclosed condition.

Thus, by providing the projection 46 having different elastic characteristics at the tip end of the lip portion 41 and deforming the projection 46, ink suction can be performed for a plurality of ejection openings having different flow resistance in just proportion without moving the cap in left and right direction. Accordingly, since the cap is not required to move in the direction perpendicular to arrangement direction of the ejection openings, it is applicable for the apparatus having no space for movement. On the other hand, drive mechanism can also be simplified.

(Third Embodiment)

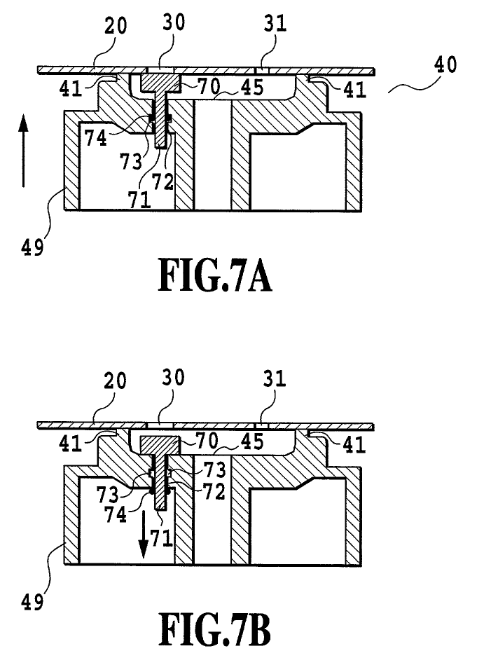

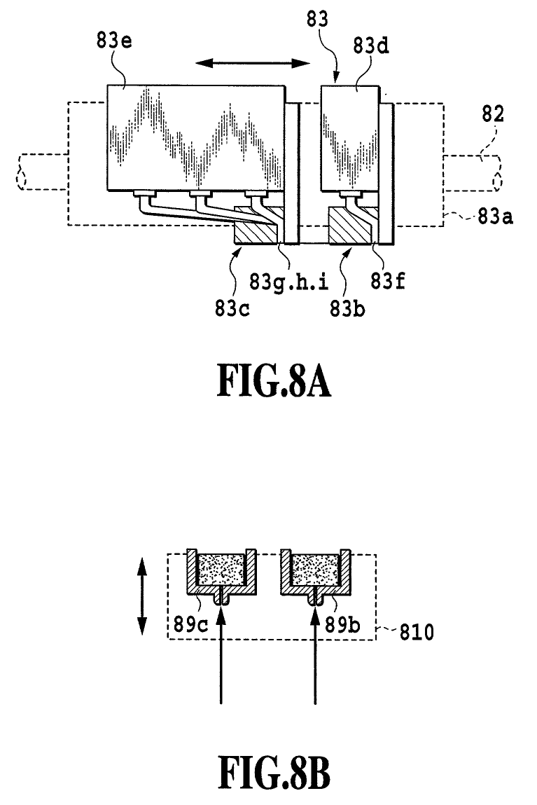

FIGS. 7A and 7B are section of the shown embodiment of the cap.

The lip portion 41 of the shown embodiment of the cap 40 is similar to the first embodiment. However, as shown in FIG. 7A, a projecting portion 70 is not fixed to the base portion 49 as in the first and second embodiments. Similarly to the first embodiment, the shape of the projecting portion 70 is a rectangular parallelepiped shape elongated in the longitudinal direction of the cap 40 along the rows of the ejection openings. At several portions of the projecting portion 70 on the surface opposing with the ejection opening face, support stems 71 are formed integrally. The support stems 71 extend toward the base portion 49 and is inserted into the support holes 72. Furthermore, in a part of the support shaft 71, ring shaped stopper 74 is provided. On the other hand, in a part of the support hole 72, a recess 73 is provided surrounding the support hole 72.

It should be noted that other portions of the cap 40, such as ink suction opening 45, the base portion 49 and so on are the same as the first embodiment. On the other hand, the ejection openings 30 formed on the ejection opening face 20 have low flow resistance in comparison with the ejection openings 31.

Similarly to the first embodiment, when the recovery process is initiated, at first, the carriage is moved at a position where the printing head opposes with the cap. Then, when the printing head reaches the position opposing to the cap, the cap 40 is elevated to contact with the ejection opening face 20 of the printing head. Contact is performed that the lip portion 41 surrounds both of the ejection openings 30 and 31.

Then, by not shown driving means, the projecting portion 70 is elevated upward to seal the ejection openings 30 (see FIG. 7A). At this time, stopper 74 penetrates into the recess 73. This condition is taken as the first recover stage. Then, in the similar state to the first embodiment, the suction pump is driven to perform suction from the ejection openings 31. At this time, by the projection portion 70, the ejection openings 30 are completely sealed. Also, since the stopper 74 enters into the recess 73, an airtight sealing of the gap between the support stem 71 and the support hole 72 is accomplished. By this, the suction force of the suction pump effectively acts on the ejection openings 31.

It should be noted that the driving means of the projecting portion 70 takes, for example, the carriage motor in the ink-jet printing apparatus 1 as driving source, and includes cam mechanism driven via the gear. The driving means of the projecting portion 70 may also be formed with an actuator performing reciprocal linear motion, such as plunger type solenoid.

When suction process from the ejection openings 31 is completed, the projecting portion 70 is lowered by not shown driving means to release seal for the ejection openings. (see FIG. 7B). This condition is taken as the second recovery stage. Then, in the similar state as the first embodiment, the suction pump is driven to suck the ink mainly from the ejection openings 30 having low flow resistance.

Thus, by providing the vertically movable projecting portion 70 within the cap 40, the lip portion 41 of the cap 40 contact with the ejection opening face 20. Thereafter, the cap 40 per se does not move further to seal the ejection openings having low flow resistance or to release sealing. Accordingly, even in the structure having small space for moving the cap, recovery process of respective ejection openings can be performed effectively in just proportion.

(Others)

Incidentally, the present invention achieves distinct effect when applied to a print head or a printing apparatus which has means for generating thermal energy such as electrothermal transducers or laser light, and which causes changes in ink by the thermal energy so as to eject ink. This is because such a system can achieve a high density and high resolution printing.

A typical structure and operational principle thereof is disclosed in U.S. Pat. Nos. 4,723,129 and 4,740,796, and it is preferable to use this basic principle to implement such a system. Although this system can be applied either to on-demand type or continuous type inkjet printing systems, it is particularly suitable for the on-demand type apparatus. This is because the on-demand type apparatus has electrothermal transducers, each disposed on a sheet or liquid passage that retains liquid (ink), and operates as follows: first, one or more drive signals are applied to the electrothermal transducers to cause thermal energy corresponding to printing information; second, the thermal energy induces sudden temperature rise that exceeds the nucleate boiling so as to cause the film boiling on heating portions of the print head; and third, bubbles are grown in the liquid (ink) corresponding to the drive signals. By using the growth and collapse of the bubbles, the ink is expelled from at least one of the ink ejection orifices of the head to form one or more ink drops. The drive signal in the form of a pulse is preferable because the growth and collapse of the bubbles can be achieved instantaneously and suitably by this form of drive signal. As a drive signal in the form of a pulse, those described in U.S. Pat. Nos. 4,463,359 and 4,345,262 are preferable. In addition, it is preferable that the rate of temperature rise of the heating portions described in U.S. Pat. No. 4,313,124 be adopted to achieve better printing.

U.S. Pat. Nos. 4,558,333 and 4,459,600 disclose the following structure of a print head, which is incorporated to the present invention: this structure includes heating portions disposed on bent portions in addition to a combination of the ejection orifices, liquid passages and the electrothermal transducers disclosed in the above patents. Moreover, the present invention can be applied to structures disclosed in Japanese Patent Application Laid-Open Nos. 59-123670 (1984) and 59-138461 (1984) in order to achieve similar effects. The former discloses a structure in which a slit common to all the electrothermal transducers is used as ejection orifices of the electrothermal transducers, and the latter discloses a structure in which openings for absorbing pressure waves caused by thermal energy are formed corresponding to the ejection orifices. Thus, irrespective of the type of the print head, the present invention can achieve printing positively and effectively.

The present invention can be also applied to a so-called full-line type print head whose length equals the maximum length across a printing medium. Such a print head may consists of a plurality of print heads combined together, or one integrally arranged print head.

In addition, the present invention can be applied to various serial type print heads: a print head fixed to the main assembly of a printing apparatus; a conveniently replaceable chip type print head which, when loaded on the main assembly of a printing apparatus, is electrically connected to the main assembly, and is supplied with ink therefrom; and a cartridge type print head integrally including an ink reservoir.

It is further preferable to add a recovery system, or a preliminary auxiliary system for a print head as a constituent of the printing apparatus because they serve to make the effect of the present invention more reliable. Examples of the recovery system are a capping means and a cleaning means for the print head, and a pressure or suction means for the print head. Examples of the preliminary auxiliary system are a preliminary heating means utilizing electrothermal transducers or a combination of other heater elements and the electrothermal transducers, and means for carrying out preliminary ejection of ink independently of the ejection for printing. These systems are effective for reliable printing.

The number and type of print heads to be mounted on a printing apparatus can be also changed. For example, only one print head corresponding to a single color ink, or a plurality of print heads corresponding to a plurality of inks different in color or concentration can be used. In other words, the present invention can be effectively applied to an apparatus having at least one of the monochromatic, multi-color and full-color modes. Here, the monochromatic mode performs printing by using only one major color such as black. The multi-color mode carries out printing by using different color inks, and the full-color mode performs printing by color mixing.

Furthermore, although the above-described embodiments use liquid ink, inks that are liquid when the printing signal is applied can be used: for example, inks can be employed that solidify at a temperature lower than the room temperature and are softened or liquefied in the room temperature. This is because in the inkjet system, the ink is generally temperature adjusted in a range of 30° C.-70° C. so that the viscosity of the ink is maintained at such a value that the ink can be ejected reliably.

In addition, the present invention can be applied to such apparatus where the ink is liquefied just before the ejection by the thermal energy as follows so that the ink is expelled from the orifices in the liquid state, and then begins to solidify on hitting the printing medium, thereby preventing the ink evaporation: the ink is transformed from solid to liquid state by positively utilizing the thermal energy which would otherwise cause the temperature rise; or the ink, which is dry when left in air, is liquefied in response to the thermal energy of the printing signal. In such cases, the ink may be retained in recesses or through holes formed in a porous sheet as liquid or solid substances so that the ink faces the electrothermal transducers as described in Japanese Patent Application Laid-Open Nos. 54-56847 (1979) or 60-71260 (1985). The present invention is most effective when it uses the film boiling phenomenon to expel the ink.

Furthermore, the ink jet recording apparatus of the present invention can be employed not only as an image output terminal of an information processing device such as a computer, but also as an output device of a copying machine including a reader, and as an output device of a facsimile apparatus having a transmission and receiving function.

By employing the present invention, upon covering the ejection opening face with the cap at the predetermined position, the projecting portion is contacted with the predetermined row of the ejection openings, such as the ejection openings having low flow resistance to seal the predetermined row of the ejection openings. By performing suction in this condition, ink is sucked from the row of the ejection openings other than the predetermined row of ejection openings. Then, after sufficiently sucking the ink from the row of ejection openings other than the predetermined row of ejection openings, the cap is moved to release sealing by the projecting portion to effect sucking. Then, ink is sucked from the predetermined row of ejection openings. Thus, ink can be sucked from all of the ejection openings in just proportion. Therefore, satisfactory recovery process can be performed for all of the ejection openings having different flow resistance and can provide compact ink-jet printing apparatus and ejection recovery method.

Also, by further providing the modified lip portion to the lip portion of the cap, seal by the projecting portion can be released only by weakening the contact force to be exerted on the cap without the cap in parallel to the ejection opening surface after the first recover stage is completed, so that it becomes applicable for the apparatus having no space to move the cap. Also, the cap drive mechanism can be simplified.

Also, by providing the mechanism for driving only projecting portion, once the cap abuts on the ejection opening, the first recovery stage and the second recovery stage can be performed without moving the cap for achieving space saving.

The present invention has been described in detail with respect to preferred embodiments, and it will now be apparent from the foregoing to those skilled in the art that changes and modifications may be made without departing from the invention in its broader aspects, and it is the intention, therefore, in the appended claims to cover all such changes and modifications as fall within the true spirit of the invention.

What is claimed is:

1. An ink-jet printing apparatus including a printing head having a plurality of ejection openings and a cap for covering an ejection opening face provided with said plurality of ejection openings of said printing head, and suction means for sucking ink from said ejection openings covered by said cap, comprising:
a sealing member provided within said cap and for sealing a part of said plurality of ejection openings;
wherein when said part of said plurality of ejection openings are sealed by said sealing member, said suction means sucks ink from ejection openings not sealed by said sealing member.

2. The ink-jet printing apparatus as claimed in claim 1, wherein said suction means selectively performs operation for sucking ink after sealing said part of said plurality of ejection openings by said sealing member and operation for sucking ink without sealing said part of said plurality of ejection openings by said sealing member.

3. The ink-jet printing apparatus as claimed in claim 1 or 2, wherein said plurality of ejection openings include ejection openings having relatively smaller ink flow resistance and ejection openings having relatively larger ink flow resistance,
said part of said plurality of ejection openings to be sealed by said sealing member are those having smaller ink flow resistance.

4. The ink-jet printing apparatus as claimed in claim 1 or 2, wherein said plurality ejection openings include ejection openings having relatively greater ink ejection amount in one ejection operation and ejection openings having relatively smaller ink ejection amount in one ejection operation, and
said part of said plurality of ejection openings to be sealed by said sealing member are those having greater ink ejection amount in one ejection operation.

5. The ink-jet printing apparatus as claimed in claim 1 or 2, wherein a plurality of rows of ejection openings provided with a plurality of ejection openings are arranged on said ejection opening face,
said sealing member including a projecting portion of the size capable of sealing predetermined rows of ejection openings when said cap covers said ejection opening face, seals said predetermined rows of ejection openings by contacting said projecting portion with said predetermined rows of ejection openings.

6. The ink-jet printing apparatus as claimed in claim 1, wherein said printing head generates bubble in the ink by a thermal energy and ejects the ink in a form of droplet based on generation of bubble.

7. An ink-jet printing apparatus having a cap for covering an ejection opening face provided with a plurality of ejection openings of a printing head,
wherein said cap comprising:
a projecting lip portion surrounding said plurality of ejection openings when said cap covers said ejection opening face; and
a projecting portion formed inside surrounded by said lip portion and for sealing a part of said plurality of ejection openings, and
wherein when said lip portion contacts with said ejection opening face at a predetermined position, said projecting portion seals said part of said plurality of ejection openings, and when said cap moves in a direction parallel to said ejection opening face to contact with said ejection opening face at a position different from said predetermined position, said projecting portion does not seal said part of said plurality of ejection openings.

8. An ink-jet printing apparatus having a cap for covering an ejection opening face provided with a plurality of ejection openings of a printing head,
wherein said cap comprising:
a projecting lip portion surrounding said plurality of ejection openings when said cap covers said ejection opening face;
a deformable lip portion formed at the projecting tip end of said lip portion; and
a projecting portion formed inside surrounded by said lip portion and for sealing a part of said plurality of ejection openings, and
wherein when said lip portion is applied a predetermined contact force at a predetermined position to contact with said ejection opening face, said deformable lip portion is deformed and said projecting portion seals said part of said plurality of ejection openings, and when said lip portion is applied a force less than said predetermined contact force at the predetermined position to contact with said ejection opening face, said deformable lip portion is not deformed and said projecting portion does not seal said part of said plurality of ejection openings.

9. The ink-jet printing apparatus as claimed in claim 8, wherein said lip portion and said deformable lip portion are formed with an elastic member, said deformable lip has higher elastic modulus than said lip portion.

10. An ink-jet printing apparatus having a cap for covering an ejection opening face provided with a plurality of ejection openings of a printing head,
wherein said cap comprising:
a projecting lip portion surrounding said plurality of ejection openings when said cap covers said ejection opening face;
a projecting portion formed inside surrounded by said lip portion and for sealing a part of said plurality of ejection openings; and
projecting portion actuating portion for moving said projecting portion for sealing said part of said plurality of ejection openings when suction process of the ejection openings other than said part of said plurality of ejection openings is performed, and for moving said projecting portion for releasing the seal of said part of said plurality of ejection openings while suction process of said part of said plurality of ejection openings is performed.

11. An ejection recovery processing method of an ejection port comprising:
covering step of covering by a cap an ejection opening face provided with a plurality of ejection openings;
sealing step for sealing a part of said plurality of ejection openings by a sealing member provided within said cap; and
suction step for sucking ink from ejection openings not sealed by said sealing member in said sealing step.

12. The recovery processing method of an ejection port as claimed in claim 11, wherein said plurality of ejection openings include ejection openings having relatively smaller ink flow resistance and ejection openings having relatively larger ink flow resistance,
said part of said plurality of ejection openings to be sealed in said sealing step are those having smaller ink flow resistance.

13. The recovery processing method of an ejection port as claimed in claim 11, wherein said plurality ejection openings include ejection openings having relatively greater ink ejection amount in one ejection operation and ejection openings having relatively smaller ink ejection amount in one ejection operation,
said part of said plurality of ejection openings to be sealed in said sealing step are those having greater ink ejection amount in one ejection operation.

14. The recovery processing method of an ejection port as claimed in claim 11, wherein a plurality of rows of ejection openings provided with a plurality of ejection openings are arranged on said ejection opening face, and
in said sealing step, when said cap covers said ejection opening face, a projecting portion of the size capable of sealing predetermined rows of ejection openings is contacted with said predetermined rows of ejection openings to seal said predetermined rows of ejection openings.
